(19) United States
(12) Patent Application Publication
(10) Pub. No.: US 2016/0256358 A1
(43) Pub. Date: Sep. 8, 2016

(54) MILK PACI

(71) Applicant: Dianne P. Freeman, Piedmont, SC (US)

(72) Inventor: Dianne P. Freeman, Piedmont, SC (US)

(21) Appl. No.: 14/636,260

(22) Filed: Mar. 3, 2015

(51) Int. Cl. A61J 9/02; B65D 23/00; B65D 1/10; A61J 9/00; A61J 17/00

(52) U.S. Cl. CPC A61J 9/02; A61J 9/008; A61J 17/00; B65D 1/10; B65D 23/00

(57) ABSTRACT

A milk paci comprises a thermos which is divided into two different sections, a first or top section for cooling and a second or lower section for heating. The first and second sections further define receptacles for temporarily placing or housing one or more baby pacifiers for achieving a desired section temperature. The thermos is mounted to a base portion which houses the circuitry, rechargeable batteries and switches used for managing thermos temperature control. In use, the first or top section of the thermos is used for cooling milk wherein the second or lower section is used for heating the milk. Cooling and heating is done with the help of the batteries and switches used simultaneously wherein the heating temperature is accurately monitored and controlled by sensors and circuitry housed within the thermos base portion.

### FIELD OF THE INVENTION

The present invention relates to a thermos that provides simultaneously both heating and. More particularly it is related to a multi sectional thermos for keeping a baby pacifier at various temperatures.

### BACKGROUND OF THE INVENTION

Most infants prefer liquid/food to be 98° F.+/−10° F. (36° C.+/−5.5° C.) which requires a heating method. Most heating methods are slow and can potentially overheat the contents leading to the possibility of scalding. In addition, microwave ovens are disfavored for warming breast milk due to potential nutrient loss and lack of precise temperature control.

The principles of thermal energy storage in phase-change materials are known. A salt solution may be “supersaturated”, i.e. containing more than the equilibrium amount of dissolved solute at a specific temperature. A typical salt used is a solution of sodium acetate trihydrate (NaC₂H₃O₂.3H₂O). The sodium acetate trihydrate can also be a “super cooled” solution, where it is cooled below its freezing point without transforming into a solid. Sodium acetate has a freezing point of 131° F. (54° C.), but can easily exist as a super cooled liquid at room temperature. The supersaturated, super cooled solution of sodium acetate is unstable and will crystallize if a seed crystal is present or a disturbance causes initiation of crystallization. This crystallization to a solid is exothermic, meaning it releases heat. The transition of sodium acetate trihydrate to solid form rapidly warms the salt solution, up to a maximum of approximately 54° C. (131° F.). It will stay at approximately this temperature until all of the sodium acetate has crystallized and the stored chemical energy has been completely converted to thermal energy. The energy so released may be put to practical use in many ways.

Super saturation is achieved by first heating a solution of salt in water to above the crystal melt point, thereby allowing the ions to completely dissociate their bonds and dissolve in the water, then cooling the solution. For example, the melt point for sodium acetate trihydrate is 54° C. (131° F.). Super saturation can be achieved by heating a solution of sodium acetate trihydrate to at least 54° C. (131° F.) until all crystals are dissolved, then cooling the solution to room temperature (approximately 20° C. or 68° F.).

Crystallization can be induced by introducing a crystal nucleus at a temperature below melt point, or by creating a crystal nucleus by compressing a small portion of solution in a trigger to induce crystallization, which then cascades throughout the solution. This crystallization is an exothermic process at room temperature, and the heat given off can be used as a heat source, such as for heating food. After the solution has crystallized the supersaturated solution can be regenerated by reheating the solution to above melt point, until the crystals completely dissolve, and then allowing the solution to cool again. The supersaturated solution remains dissolved and will not spontaneously nucleate even at normal refrigerator temperatures of (1-3° C.) 33-38° F., unless initiated by a trigger or nucleate crystal.

The maximum temperature is self-limited by the maximum temperature of the salt solution undergoing crystallization. For example, a typical supersaturated solution of sodium acetate trihydrate reaches a maximum temperature of approximately 54° C. (131° F.) when triggered from room temperature. This heat energy can be transferred to food within a container through the walls of a heating element within the container. Similarly, in certain instances a desire to provide cooling may be desired. For example, caregivers may want to keep their infants milk cold as well. Therefore, a need exists to provide both heating and cooling in the feeding and nutritional care of small infants. The present invention solves this and many other problems in a unique and novel fashion.

### SUMMARY OF THE INVENTION

A milk paci comprises a thermos which is divided into two different sections, a first or top section for cooling and a second or lower section for heating. The first and second sections further define receptacles for temporarily placing or housing one or more baby pacifiers for achieving a desired section temperature. The thermos is mounted to a base portion which houses the circuitry, rechargeable batteries and switches used for managing thermos temperature control. In use, the first or top section of the thermos is used for cooling milk wherein the second or lower section is used for heating the milk. Cooling and heating is done with the help of the batteries and switches used simultaneously wherein the heating temperature is accurately monitored and controlled by sensors and circuitry housed within the thermos base portion.

In accordance with a preferred embodiment, users have four pacifiers for carrying milk which first are inserted in the cooling section receptacles located near or at the top of the thermos. When a baby's hungry, a pacifier is removed from the cooling area and placed at heating section receptacles located near the base of the thermos wherein the temperature is set anywhere from room temperature to 98.5 degree which is suitable for most babies. After heating, a pacifier is removed from the thermos and given to the infant. Therefore, users place and change the location of the pacifiers as per their needs. Using the thermos of the present invention, users may now keep their infants milk at various temperatures as per their infant's needs.

### BRIEF DESCRIPTION OF THE DRAWINGS

FIG. 1 graphically illustrates a commercially available baby pacifier for use with the present invention;

FIG. 2 is a graphical representation of an assembled thermos with base portion in accordance with the present invention; and

FIG. 3 is a graphical representation of an exploded view of the thermos shown in FIG. 2 for illustrating features of the present invention.

### DETAIL DESCRIPTION OF THE INVENTION

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

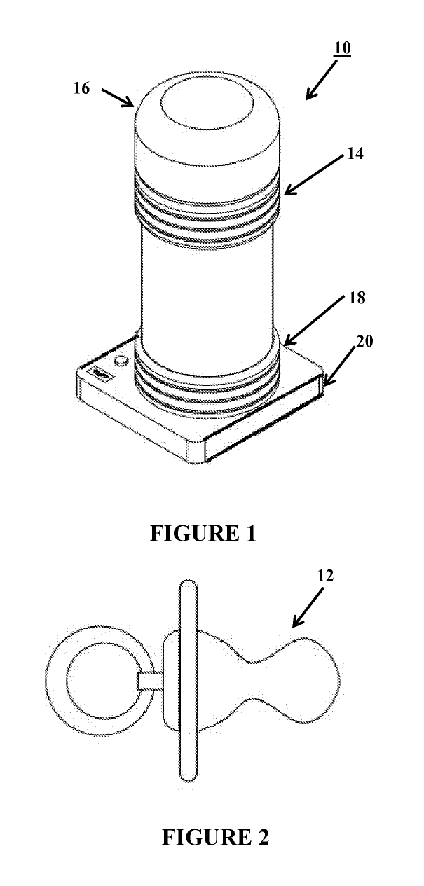

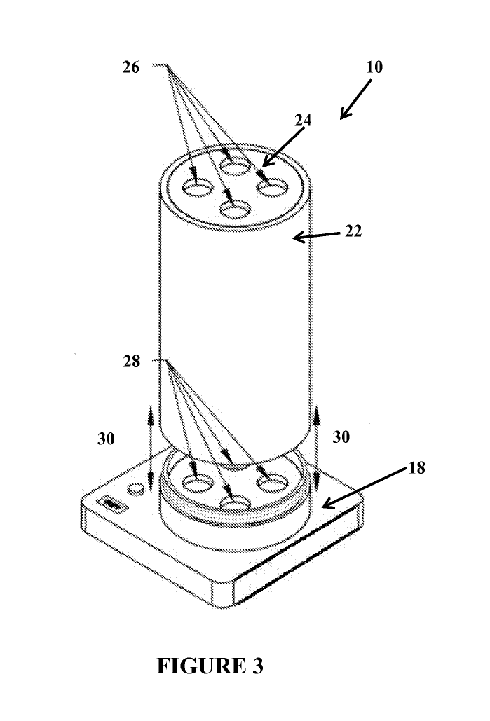

Referring now to FIG. 1, a thermos 10 for cooling and heating milk simultaneously is provided. The thermos 10 comprises a heating section 18 and a cooling section 14 for changing and/or maintaining the temperature of a commercial baby pacifier 12 as shown in FIG. 2. The thermos 10 has a top lid 16 and is mounted at its bottom to a base portion 20 which houses the batteries, on/off switches and circuitry (not shown) for starting and maintaining the temperature of thermos 10. Additionally, there also may be sensors (not shown) in thermos base 20 for maintaining the heating and cooling.

Referring now to FIG. 2, the thermos 10 defines an inner chamber 22 which includes a thin stationery top 24 with four nipple receptacles on top 26 and four nipple receptacles located at the bottom half 28 for placing pacifiers 12. In one preferred embodiment, there are four pacifiers for putting the milk and placing them into the thermos 10. By way of example, but not of limitation, a pacifier holder size would be approximate 2.25 ounces wherein the end of the pacifier 12 would be manually pushed into either the top or bottom four nipple receptacles 24 and 26 respectively. As shown in FIG. 2, users twist or unscrew 30 the thermos 10 for detaching and reattaching the bottom section 18 of thermos 10.

It should be understood that the milk paci of the present invention keeps milk hot and cold simultaneously in the same flask. Users could fix all four pacifiers and put them in the cooling or first section, once they pack to leave home and would have to push a button to keep the milk safe from curdling. When they got ready to feed their baby, they just unscrew the pacifiers and place as many pacifiers as needed in the bottom for heating the milk and then push a button for starting the heating. Heating would be controlled by sensors wherein users may keep the pacifiers at various different temperatures. Lastly, milk paci is sized to be as compact as possible to fit easily into a diaper bag. It should also be understood that the top of the bottom half is hollow for pacifier handles to fit to be heated wherein the top twist on cap is automatically hollow.

The milk paci of the present invention is a convenient way for mother's to have lunch with friends, a short shopping trip, a church service, or any little outing away from home. It is nice and easy way to make feeding of infants quick and effortless. In summary, the present invention comprises a thermos having two sections, one for cooling and another for heating. Cooling is for keeping the milk safe from curdling. And whenever babies feel hungry users can place the pacifier at the heating end thereby delivering warm milk. Users just have to twist off the thermos for placing pacifiers in the heating section wherein each pacifier can carry two ounce milk. Heating and cooling would be done by rechargeable batteries, on/off switches and electric circuitry and users would manage the temperature primarily through the use of the on/off switches. It would be suitable for 0 to 12 months babies.

What is claimed is:

1. A milk paci, comprising:
a thermos divided into a first top section for cooling and a second bottom section for heating wherein said second bottom section is mounted to a base portion; and
said first top section and said second bottom section each further define one or more nipple receptacles for temporarily housing one or more baby pacifiers wherein the interchanging of said pacifiers between sections achieve a desired temperature.

2. The milk paci according to claim 1 wherein said base portion houses circuitry, rechargeable batteries and switches used for controlling said thermos temperature.

3. The milk paci according to claim 1 wherein said base portion further houses sensors used for said thermos temperature.

4. The milk paci according to claim 1 wherein each said section defines four receptacles.

5. The milk paci according to claim 1 wherein a receptacle is sized to house a 2.25 ounce pacifier. rwherein

[symbol]

6. The milk paci according to claim 1 wherein an end of said pacifier is manually pushed into said receptacles 24

7. The milk paci according to claim 1 wherein said second bottom section may be screwed and unscrewed from said base portion.

8. The milk paci according to claim 1 wherein said milk paci is sized to be as compact as possible to fit easily into a diaper bag.

9. The milk paci according to claim 1 wherein said bottom section of said milk paci is hollow for pacifier handles to fit to be heated wherein said top section top is a hollow twist on cap.
